(19) United States
(12) Patent Application Publication
(10) Pub. No.: US 2026/0253434 A1
(43) Pub. Date: Aug. 27, 2026

(54) GENERATING LABELS FOR IMAGES USING PROCESS SUPERVISION

(71) Applicant: Bytedance Technology Ltd., Grand Cayman (KY)

(72) Inventors: Mingchao Liu, Culver City, CA (US); Hongyu Xiong, Culver City, CA (US); Yu Sun, Los Angeles, CA (US); Xin Dong, Culver City, CA (US); Ruixiao Sun, Los Angeles, CA (US)

(21) Appl. No.: 19/060,377

(22) Filed: Feb. 21, 2025

(51) Int. Cl. G06V 20/70; G06F 40/284; G06V 10/77

(52) U.S. Cl. CPC G06V 20/70; G06F 40/284; G06V 10/7715

(57) ABSTRACT

A computing system is provided for generating a label for an input image using process supervision. The computing system includes a processing circuitry and memory storing instructions that, when executed, cause the processing circuitry to receive the input image and an input text, generate a token sequence by integrating features from the input image and the input text, and incorporating a plurality of questions, including a final question, into the token sequence, process the token sequence using a transformer language model to generate a sequence of hidden representations, project a plurality of question hidden representations corresponding to the plurality of questions into a predicted answer space to generate a plurality of answers, project a final hidden representation of the final question into the predicted answer space to generate and output the label for the input image and the input text.

### BACKGROUND

Process supervision is a machine learning technique that generates intermediate labels to structure and simplify complex tasks. By introducing intermediate supervision stages in the training of machine learning models, additional checkpoints for learning and error correction can be provided to enhance the robustness of the trained models. Accordingly, models can break down complex problems into more manageable steps to increase overall performance.

Conventionally, data sets with human-annotated intermediate labels have been used train machine learning models. However, the human annotation of intermediate labels may be both time-consuming and expensive. Furthermore, the need for manual annotations limits the scalability and practicality of process supervision, especially for large and diverse data sets.

### SUMMARY

In view of the above issues, a computing system is provided for generating a label for an input image using process supervision. The computing system includes a processing circuitry and memory storing instructions that, when executed, cause the processing circuitry to receive the input image and an input text, tokenize the input text to generate a plurality of text tokens, extract visual features from the input image, transform the visual features into modality-aligned representation tokens, and generate a token sequence by integrating the text tokens and the modality-aligned representation tokens, and incorporating a plurality of questions, including a final question, into the token sequence. The system processes the token sequence using a transformer language model to generate a sequence of hidden representations, projects a plurality of question hidden representations corresponding to the plurality of questions into a predicted answer space to generate a plurality of answers, and projects a final hidden representation of the final question into the predicted answer space to generate and output the label for the input image and the input text.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates a schematic view of a computing system according to an example of the present disclosure.

FIG. 2 illustrates a schematic view of the operations of the trained machine learning labeling model of the computing system of FIG. 1.

FIG. 3 illustrates a detailed schematic of an example of the inputs and outputs of the trained machine learning labeling model of FIGS. 1 and 2.

FIG. 4 is a table with experimental data showing the end-to-end prediction performance of the trained machine learning labeling model of FIGS. 1 and 2 relative to the performance of conventional models.

FIG. 5 is a flow chart of a method for generating a label according to an example embodiment of the present disclosure.

FIG. 6 shows an example computing environment of the present disclosure in which the computing system of FIG. 1 may be enacted.

### DETAILED DESCRIPTION

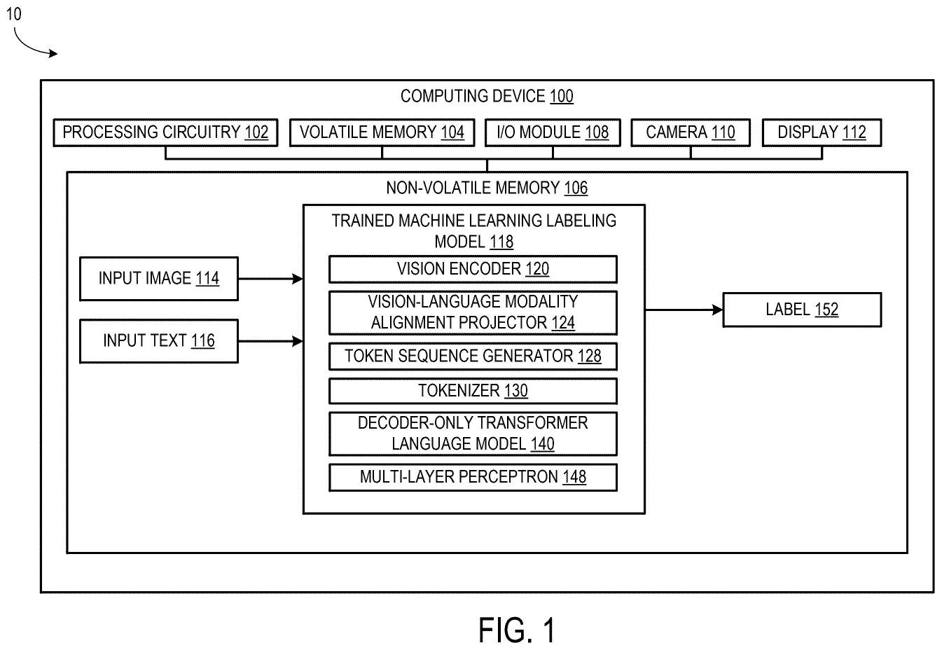

FIG. 1 shows a schematic view of an example computing system 10 including a computing device 100 for generating a label 152 using process supervision. The computing device 100 includes processing circuitry 102 (e.g., central processing units, or “CPUs”), volatile memory 104, non-volatile memory 106, an input/output (I/O) module 108, a camera 110, and a display 112. The different components are operatively coupled to one another. The non-volatile memory 106 stores instructions for the processing circuitry 102 to execute a trained machine learning labeling model 118 which is configured to receive an input image 114 and input text 116 and generate a label 152 based on the input image 114 and the input text 116.

In one embodiment, a user provides an input image 114 and input text 116. The input image 114 and the input text 116 corresponding to the input image 114 may be extracted from a social media post, a digital photo album, or video frames from a video, for example. The labeling model 118 includes a vision encoder 120 configured to extract visual features from the input image 114, a vision-language modality alignment projector 124 configured to transform the visual features into modality-aligned representation tokens. The labeling model 118 further includes a tokenizer 130 configured to tokenize the input text 116 into text tokens. A token sequence generator 128 generates a token sequence by integrating text tokens and the modality-aligned representation tokens, and incorporating a plurality of questions, including a final question, into the token sequence. A decoder-only transformer language model 140 of the labeling model 118 processes the token sequence to generate a sequence of hidden representations. A multi-layer perceptron 148 projects the hidden representations into a predicted answer space to generate a plurality of answers.

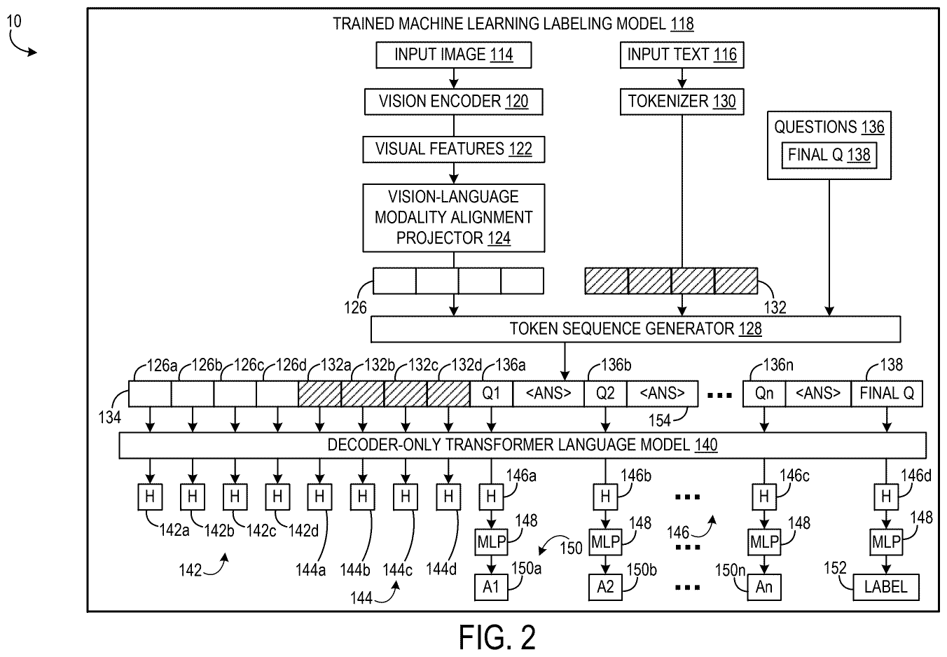

FIG. 2 shows a detailed schematic view of the processes of the trained machine learning labeling model 118 of FIG. 1 from receiving the input image 114 and input text 116 to generating the label 152 based on the input image 114 and the input text 116. The input text 116 is processed by a tokenizer 130, which tokenizes the input text 116 to generate a plurality of text tokens 132. The input image 114 is processed by a vision encoder 120, which is configured to extract visual features 122 from the input image 114. The vision features 122 are then passed through a vision-language modality alignment projector 124 to map the visual features 122 into a shared representation space for visual and textual modalities, so that the visual features 122 are transformed into modality-aligned representation tokens 126 which can be integrated with the text tokens 132.

A token sequence generator 128 integrates the modality-aligned representation tokens 126 and the text tokens 132 to generate a token sequence 134. The token sequence generator 128 also incorporates a plurality of questions 136, including a final question 138, into the generated token sequence 134. As shown in the example of FIG. 2, the token sequence 134 includes a plurality of modality-aligned representation tokens 126a-d, a plurality of text tokens 132a-d, a plurality of intermediate questions 136a-n, and a final question 138. Each intermediate question may concludes with a predetermined placeholder token 154, such as an <ans> token.

The token sequence 134 is processed by a decoder-only transformer language model 140 to generate a sequence of hidden representations 142, 144, 146. Each hidden representation 142, 144, 146 corresponds to a token in the token sequence 134. Thus, each vision-based hidden representation 142a-d corresponds to its respective modality-aligned representation 126a-d, each text-based hidden representation 144a-d corresponds to its respective text token 132a-d, each question hidden representation 146a-c corresponds to its respective question 136a-n, and the final question 138 corresponds to the final hidden representation 146d. During process supervision, N-rounds of intermediate questions 136a-n are introduced as additional inputs into the transformer language model 140. These intermediate questions follow the text tokens 132a-d and precede the final question 138, which targets the ultimate labeling-specific output. Since the transformer language model 140 is an inherently sequential model, each hidden representation 142, 144, 146 depends on all preceding tokens. Through such an integration of the intermediate steps during process supervision, the labeling model 118 may refine its understanding and progressively adjust its hidden state, so that the final hidden representation 146d reflects the context and reasoning derived by the intermediate questions 136a-n.

The question hidden representations 146 corresponding to the intermediate questions 136a-n are processed by a multi-layer perceptron (MLP) 148, which projects the question hidden representations 146 into a predicted answer space to generate answers 150a-n, 152. Finally, the final hidden representation 146d of the final question 138 is passed through the MLP 148, which generates and outputs a prediction of the answer to the final question 138 as the label 152 for the input image 114 and the input text 116.

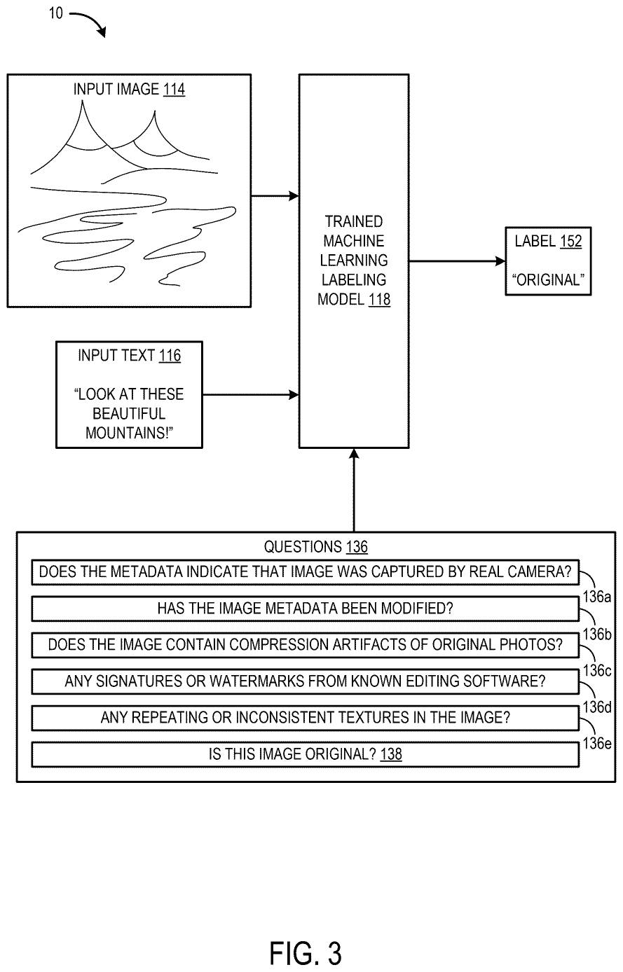

Turning to FIG. 3, an example is illustrated of an input image 114 and an input text 116 that may be inputted into a trained machine learning labeling model 118 to generate a label 152 corresponding to the input image 114. In this example, the input image 114, extracted from a social media post, shows a picturesque scene of a river with mountains in the background. The input text 116, “Look at these beautiful mountains!”, was extracted from a comment in the social media post which featured the input image 114.

During process supervision, questions 136 are introduced as additional inputs to refine the understanding of the labeling model 118. In this example, the questions 136 include five intermediate questions 136a-e leading up to the final question 138. The intermediate questions 136a-e derive context and reasoning which aid the labeling model 118 in asking the final question 138, whether or not the input image 114 is original. The first intermediate question 136a asks whether the metadata of the input image 114 indicates that the input image 114 was captured by a real camera. The second intermediate question 136b asks whether the metadata of the input image 114 has been modified. The third intermediate question 136c asks whether the input image 114 contains compression artifacts consistent with original photos. The fourth intermediate question 136d asks whether the input image 114 has any signatures or watermarks from known editing software. The fifth intermediate question 136e asks whether there are any repeating or inconsistent textures in the input image 114.

Following the last intermediate question 136e, the final question 138 asks whether or not the input image 114 is original. In this example, the labeling model 118 generates and output a label 152 indicating that the input image 114 is original.

Although an implementation of the labeling model 118 to determine the originality of an input image 114 is illustrated in this example, it will be appreciated that the implementation of the architecture of the labeling model 118 is not particularly limited to determining the originality of images. For example, the labeling model 118 may be configured to label the input image 114 based on a content quality of the input image 114, or label the input image 114 based on predetermined content criteria of a content platform. For example, the label 152 may indicate whether the input image 114 meets predetermined content criteria.

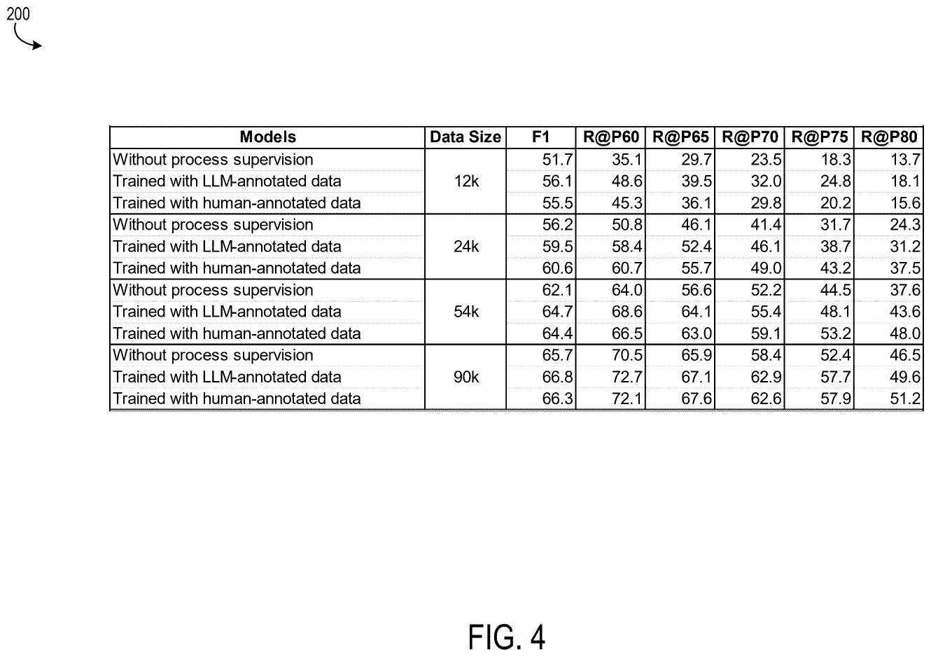

Turning to FIG. 4, a table 200 illustrates a comparative analysis of labeling model performance conducted by the present inventors based on varying sizes of training datasets. The evaluation compares a conventional labeling model that does not use process supervision, a labeling model of the present disclosure trained using data annotated by a large language model (LLM), and a labeling model of the present disclosure trained using data annotated by human annotators. Performance evaluation was conducted using six key metrics: F1, R@P60, R@P65, R@P70, R@P75, R&P80.

The F1 performance metric quantifies the accuracy of a labeling model by considering both precision and recall, defined as the harmonic mean of precision and recall. A higher F1 score indicates a more balanced trade-off between precision and recall.

The R@P60 performance (Recall at Precision 60%) is a recall-based evaluation metric wherein recall is measured under the constraint that precision is at least 60%. This metric ensures that the model maintains a minimum level of precision while optimizing recall. Likewise, the R@P65, R@P70, R@P75, and R&P80 performance metrics measure recall under the constraint that precision is at least 65%, 70%, 75%, and 80%, respectively.

Referring to the performance of the labeling models trained on a dataset of 90,000 labeled instances, the conventional labeling model trained without process supervision achieved an F1 performance of 65.7 and an R@P60 performance of 70.5. The labeling model of the present disclosure trained using data annotated by a large language model (LLM) achieved an F1 performance of 66.8, demonstrating an improvement over the conventional model. The corresponding R@P60 performance was 72.7, further indicating enhanced recall while maintaining the specified precision threshold. Further, the labeling model of the present disclosure trained using data annotated by human annotators achieved an F1 performance of 66.3, which is higher than that of the conventional model but slightly lower than the LLM-annotated model. The R@P60 performance for this model was 72.1, indicating improved recall over the conventional model while maintaining high precision.

These results indicate that the labeling models of the present disclosure, whether trained on LLM-annotated data or human-annotated data, outperform conventional labeling models across key performance metrics. Furthermore, the labeling model trained with LLM-annotated data demonstrates higher labeling performance across multiple metrics, suggesting that LLM-based annotation provides an effective means of enhancing model training efficiency and generalization.

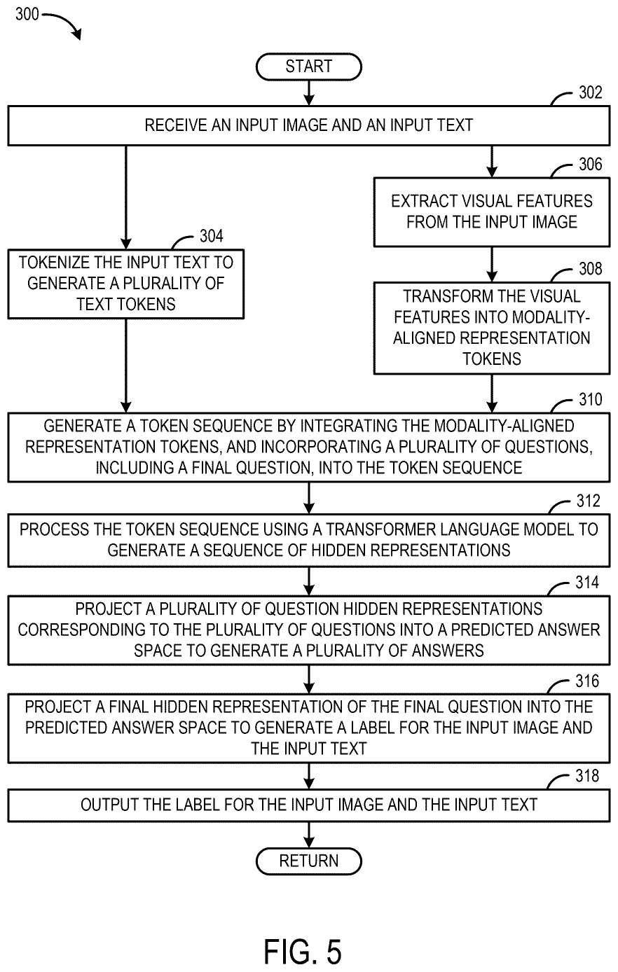

FIG. 5 shows a process flow diagram of an example method 300 for generating a label for an input image. The example method 300 may be executed by the processing circuitry 102 and memory 104 of the computing system 10 of FIG. 1. The example method 300 includes, at step 302, receiving an input image and an input text. The example method 300 includes, at step 304, tokenizing the input text to generate a plurality of text tokens. At step 306, the method 300 includes extracting visual features from the input image, and at step 308, transforming the visual features into modality-aligned representation tokens. At step 310, the method 300 includes generating a token sequence by integrating the text tokens and the modality-aligned representation tokens, and incorporating a plurality of questions, including a final question, into the token sequence.

At step 312, the method 300 includes processing the token sequence using a transformer language model to generate a sequence of hidden representations, and at step 314, projecting a plurality of question hidden representations corresponding to the plurality of questions into a predicted answer space to generate a plurality of answers. Method 300 further includes step 316 of projecting a final hidden representation of the final question into the predicted answer space to generate a label for the input image and the input text, and step 318 of outputting the label for the input image and the input text.

As described throughout herein, process supervision refines the understanding of the labeling model, thereby increasing the accuracy of the outputted label. The intermediate questions inputted into the transformer language model serve as additional inputs that provide context and reasoning, which is reflected in the final output. This enhanced accuracy in labeling models has applications beyond assessing the originality of images. For example, it can also be employed to screen content for adherence to platform-specific criteria on a content platform.

In some embodiments, the methods and processes described herein may be tied to a computing system of one or more computing devices. In particular, such methods and processes may be implemented as a computer-application program or service, an application-programming interface (API), a library, and/or other computer-program product.

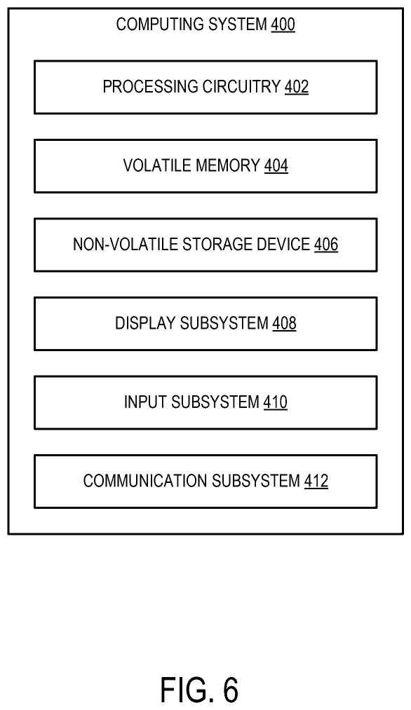

FIG. 6 schematically shows a non-limiting embodiment of a computing system 400 that can enact one or more of the methods and processes described above. Computing system 400 is shown in simplified form. Computing system 400 may embody the computing system 10 described above and illustrated in FIG. 1. Components of computing system 400 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 400 includes processing circuitry 402, volatile memory 404, and a non-volatile storage device 406. Computing system 400 may optionally include a display subsystem 408, input subsystem 410, communication subsystem 412, and/or other components not shown in FIG. 6.

Processing circuitry 402 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 402 may be single-core or multi-core, and the instructions executed thereon may be configured for sequential, parallel, and/or distributed processing. Individual components of the processing circuitry 402 optionally may be distributed among two or more separate devices, which may be remotely located and/or configured for coordinated processing. For example, aspects of the computing system disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 402.

Non-volatile storage device 406 includes one or more physical devices configured to hold instructions executable by the processing circuitry 402 to implement the methods and processes described herein. When such methods and processes are implemented, the state of non-volatile storage device 406 may be transformed—e.g., to hold different data.

Non-volatile storage device 406 may include physical devices that are removable and/or built in. Non-volatile storage device 406 may include optical memory, semiconductor memory, and/or magnetic memory, or other mass storage device technology. Non-volatile storage device 406 may include nonvolatile, dynamic, static, read/write, read-only, sequential-access, location-addressable, file-addressable, and/or content-addressable devices. It will be appreciated that non-volatile storage device 406 is configured to hold instructions even when power is cut to the non-volatile storage device 406.

Volatile memory 404 may include physical devices that include random access memory. Volatile memory 404 is typically utilized by processing circuitry 402 to temporarily store information during processing of software instructions. It will be appreciated that volatile memory 404 typically does not continue to store instructions when power is cut to the volatile memory 404.

Aspects of processing circuitry 402, volatile memory 404, and non-volatile storage device 406 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 400 typically implemented in software by a processor to perform a particular function using portions of volatile memory, which function involves transformative processing that specially configures the processor to perform the function. Thus, a module, program, or engine may be instantiated via processing circuitry 402 executing instructions held by non-volatile storage device 406, using portions of volatile memory 404. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 408 may be used to present a visual representation of data held by non-volatile storage device 406. The visual representation may take the form of a graphical user interface (GUI). As the herein described methods and processes change the data held by the non-volatile storage device, and thus transform the state of the non-volatile storage device, the state of display subsystem 408 may likewise be transformed to visually represent changes in the underlying data. Display subsystem 408 may include one or more display devices utilizing virtually any type of technology. Such display devices may be combined with processing circuitry 402, volatile memory 404, and/or non-volatile storage device 406 in a shared enclosure, or such display devices may be peripheral display devices.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The following paragraphs provide additional description of the subject matter of the present disclosure. One aspect provides a computing system for generating a label for an input image using process supervision, the computing system comprising processing circuitry and memory storing instructions that, when executed, cause the processing circuitry to receive the input image and an input text, tokenize the input text to generate a plurality of text tokens, extract visual features from the input image, transform the visual features into modality-aligned representation tokens, generate a token sequence by integrating the text tokens and the modality-aligned representation tokens, and incorporating a plurality of questions, including a final question, into the token sequence, process the token sequence using a transformer language model to generate a sequence of hidden representations, project a plurality of question hidden representations corresponding to the plurality of questions into a predicted answer space to generate a plurality of answers, project a final hidden representation of the final question into the predicted answer space to generate the label for the input image and the input text, and output the label for the input image and the input text. In this aspect, additionally or alternatively, each intermediate question may conclude with a predetermined placeholder token. In this aspect, additionally or alternatively, each token in the sequence of hidden representations may correspond to a respective token in the token sequence. In this aspect, additionally or alternatively, the hidden representations may be projected into the predicted answer space using a multi-layer perceptron. In this aspect, additionally or alternatively, the sequence of hidden representations may include vision-based hidden representations corresponding to respective modality-aligned representation tokens. In this aspect, additionally or alternatively, the sequence of hidden representations may include text-based hidden representations corresponding to respective text tokens. In this aspect, additionally or alternatively, the transformer language model may be a decoder-only model. In this aspect, additionally or alternatively, the label may indicate whether the input image is original. In this aspect, additionally or alternatively, the label may indicate whether the input image meets predetermined content criteria. In this aspect, additionally or alternatively, the modality-aligned representation tokens may be generated by mapping the visual features into a shared representation space for visual and text modalities.

Another aspect provides a computing method for generating a label for an input image using process supervision, the computing method comprising receiving the input image and an input text, tokenizing the input text to generate a plurality of text tokens, extracting visual features from the input image transforming the visual features into modality-aligned representation tokens, generating a token sequence by integrating the text tokens and the modality-aligned representation tokens, and incorporating a plurality of questions, including a final question, into the token sequence, processing the token sequence using a transformer language model to generate a sequence of hidden representations, projecting a plurality of question hidden representations corresponding to the plurality of questions into a predicted answer space to generate a plurality of answers, projecting a final hidden representation of the final question into the predicted answer space to generate the label for the input image and the input text, and outputting the label for the input image and the input text. In this aspect, additionally or alternatively, each intermediate question may conclude with a predetermined placeholder token. In this aspect, additionally or alternatively, each token in the sequence of hidden representations may correspond to a respective token in the token sequence. In this aspect, additionally or alternatively, the hidden representations may be projected into the predicted answer space using a multi-layer perceptron. In this aspect, additionally or alternatively, the sequence of hidden representations may include vision-based hidden representations corresponding to respective modality-aligned representation tokens. In this aspect, additionally or alternatively, the sequence of hidden representations may include text-based hidden representations corresponding to respective text tokens. In this aspect, additionally or alternatively, the transformer language model may be a decoder-only model. In this aspect, additionally or alternatively, the label may indicate whether the input image is original. In this aspect, additionally or alternatively, the label may indicate whether the input image meets predetermined content criteria.

Another aspect provides a computing system for generating a label for an input image using process supervision, the computing system comprising processing circuitry and memory storing instructions that, when executed, cause the processing circuitry to receive the input image and an input text, generate a token sequence by integrating features from the input image and the input text, and incorporating a plurality of questions, including a final question, into the token sequence, process the token sequence using a transformer language model to generate a sequence of hidden representations, project a plurality of question hidden representations corresponding to the plurality of questions into a predicted answer space to generate a plurality of answers, project a final hidden representation of the final question into the predicted answer space to generate the label for the input image and the input text, and output the label for the input image and the input text.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

It will be appreciated that “and/or” as used herein refers to the logical disjunction operation, and thus A and/or B has the following truth table.

| A | B | A and/or B |
|---|---|---|
| T | T | T |
| T | F | T |
| F | T | T |
| F | F | F |

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for generating a label for an input image using process supervision, the computing system comprising:
processing circuitry and memory storing instructions that, when executed, cause the processing circuitry to:
receive the input image and an input text;
tokenize the input text to generate a plurality of text tokens;
extract visual features from the input image;
transform the visual features into modality-aligned representation tokens;
generate a token sequence by integrating the text tokens and the modality-aligned representation tokens, and incorporating a plurality of questions, including a final question, into the token sequence;
process the token sequence using a transformer language model to generate a sequence of hidden representations;
project a plurality of question hidden representations corresponding to the plurality of questions into a predicted answer space to generate a plurality of answers;
project a final hidden representation of the final question into the predicted answer space to generate the label for the input image and the input text; and
output the label for the input image and the input text.

2. The computing system of claim 1, wherein each intermediate question concludes with a predetermined placeholder token.

3. The computing system of claim 1, wherein each token in the sequence of hidden representations corresponds to a respective token in the token sequence.

4. The computing system of claim 1, wherein the hidden representations are projected into the predicted answer space using a multi-layer perceptron.

5. The computing system of claim 1, wherein the sequence of hidden representations includes vision-based hidden representations corresponding to respective modality-aligned representation tokens.

6. The computing system of claim 1, wherein the sequence of hidden representations includes text-based hidden representations corresponding to respective text tokens.

7. The computing system of claim 1, wherein the transformer language model is a decoder-only model.

8. The computing system of claim 1, wherein the label indicates whether the input image is original.

9. The computing system of claim 1, wherein the label indicates whether the input image meets predetermined content criteria.

10. The computing system of claim 1, wherein the modality-aligned representation tokens are generated by mapping the visual features into a shared representation space for visual and text modalities.

11. A computing method for generating a label for an input image using process supervision, the computing method comprising:
receiving the input image and an input text;
tokenizing the input text to generate a plurality of text tokens;
extracting visual features from the input image
transforming the visual features into modality-aligned representation tokens;
generating a token sequence by integrating the text tokens and the modality-aligned representation tokens, and incorporating a plurality of questions, including a final question, into the token sequence;
processing the token sequence using a transformer language model to generate a sequence of hidden representations;
projecting a plurality of question hidden representations corresponding to the plurality of questions into a predicted answer space to generate a plurality of answers;
projecting a final hidden representation of the final question into the predicted answer space to generate the label for the input image and the input text; and
outputting the label for the input image and the input text.

12. The computing method of claim 11, wherein each intermediate question concludes with a predetermined placeholder token.

13. The computing method of claim 11, wherein each token in the sequence of hidden representations corresponds to a respective token in the token sequence.

14. The computing method of claim 11, wherein the hidden representations are projected into the predicted answer space using a multi-layer perceptron.

15. The computing method of claim 11, wherein the sequence of hidden representations includes vision-based hidden representations corresponding to respective modality-aligned representation tokens.

16. The computing method of claim 11, wherein the sequence of hidden representations includes text-based hidden representations corresponding to respective text tokens.

17. The computing method of claim 11, wherein the transformer language model is a decoder-only model.

18. The computing method of claim 11, wherein the label indicates whether the input image is original.

19. The computing method of claim 11, wherein the label indicates whether the input image meets predetermined content criteria.

20. A computing system for generating a label for an input image using process supervision, the computing system comprising:
processing circuitry and memory storing instructions that, when executed, cause the processing circuitry to:
receive the input image and an input text;
generate a token sequence by integrating features from the input image and the input text, and incorporating a plurality of questions, including a final question, into the token sequence;
process the token sequence using a transformer language model to generate a sequence of hidden representations;
project a plurality of question hidden representations corresponding to the plurality of questions into a predicted answer space to generate a plurality of answers;
project a final hidden representation of the final question into the predicted answer space to generate the label for the input image and the input text; and
output the label for the input image and the input text.
